(19) United States
(12) Patent Application Publication
(10) Pub. No.: US 2016/0050525 A1
(43) Pub. Date: Feb. 18, 2016

(54) ZONE BASED ANONYMOUS CONTENT SHARING

(71) Applicant: Yik Yak, Inc., Atlanta, GA (US)

(72) Inventors: Tyler Droll, Atlanta, GA (US); Brooks Buffington, Atlanta, GA (US)

(21) Appl. No.: 14/458,829

(22) Filed: Aug. 13, 2014

(51) Int. Cl. H04W 4/02; H04W 4/04

(52) U.S. Cl. CPC H04W 4/021; H04W 4/023; H04W 4/04; H04W 84/12

(57) ABSTRACT

Embodiments of the present disclosure may provide zone based anonymous content sharing platform. The platform may determine a first user's location. Then, a first zone may be established to correspond to the first user's location. The first user may be provided a first set of functions configured to enable the first user to interact with other users within in the first zone. Next, the platform may determine a second user's location. Upon a determination that, the second user is not located within the first zone, the platform may provide the second user with a second set of functions configured to enable the second user to interact with the other users within the first zone. The second set of functions may be a subset of the first set of functions.

### BACKGROUND

I. Field of Disclosure

The present disclosure generally relates to the field of content sharing over a telecommunications network.

II. Discussion of Related Art

Networking applications have become a pervasive means for connecting people. Some networking applications are designed to connect friends together (e.g. social networking applications), facilitate business connections (e.g., business networking applications), or connect individuals who are interested in the same subject matter (e.g., dating networking applications).

The conventional networking applications often require each party within a network to disclose their personal identity and undergo a user-initiated ‘offer and acceptance’ stage through which the parties may join each other's network. Moreover, many of the conventional networking applications are generally organized by social relationship, business dealings, or common issue, without the regard to, for example, organizational domain or geographic proximity. Unfortunately, the disclosure of personal identities, social relationships, and business dealings serves to impede and, often times, prevent the free flow of ideas and information.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in their trademarks and copyrights included herein, and grant permission to reproduce the material only in connection with reproduction of the granted patent and for no other purpose. In the drawings:

FIG. 1 is a flow chart of a method for providing a domain based anonymous content sharing platform;

FIGS. 2A-2B are wire-frame illustrating embodiments of a user interface of the platform;

FIGS. 3A-3B are wire-frame illustrating embodiments of another user interface of the platform;

FIGS. 4A-4B are wire-frame illustrating embodiments of yet another user interface of the platform;

FIGS. 5A-5B are wire-frame illustrating embodiments of still another user interface of the platform; and

FIG. 6 is a block diagram of a system including a computing device for performing various methods disclosed herein.

### DETAILED DESCRIPTION

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. The present disclosure contains headers. It should be understood that these headers are used as references and are not to be construed as limiting upon the subjected matter disclosed under the header.

I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

Consistent with embodiments of the present disclosure, a zone based anonymous content sharing platform may be provided. The platform may comprise methods, systems, devices, computer-readable media, and telecommunications networks for providing the zone based anonymous content sharing. Content may include, but not be limited to, for example, graphic, text, audio, video, and/or combinations thereof.

The platform of the present disclosure may enable users to anonymously view, post, share, or otherwise interact with content in a dynamic zone. The zone may be ‘dynamic’ in the sense that the network connections available to a platform user may be based on, for example, dynamic parameters. The dynamic parameters may include, but not be limited to, a geographic location of a user, a network location of the user, an access time, and/or other variables that may change from time-to-time. As will be detailed below, using the dynamic parameters, the platform may be configured to connect users based on, for example, their location relative each other, a region, or a predefined zone. In turn, as the dynamic parameters change (due to, for example, a change of user location), the network connections available to the platform user may also change. In this way, the zone of network connections available to the user may be dynamic, constantly changing based on updated parameters (e.g., user-location, time of access, and the like).

Still consistent with embodiments of the present disclosure, the platform may enable users to anonymously view content that is being shared in a predefined zone. The zone may be ‘predefined’ in the sense that the network connections available to a platform user within the zone may be based on, but not be limited to, for example, a content subject matter, an organizational affiliation, a geographical location, or a proximity thereto.

In some embodiments, the platform may be operative to provide users with a set of selection parameters in order to determine which predefined zone to join. For example, the user may be enabled to select, but not be limited to, a subject matter category, an organization, a location on a map, or a location of another platform user. Based on the user-selection, the platform may then connect the user to other users within the predefined zone. The other platform users within the predefined zone may be associated with the zone based on, for example, their corresponding dynamic parameters (e.g., their geographic location). In this way, a predefined zone for one platform user may correspond to, or overlap with, a dynamic zone of another platform user.

Accordingly, the platform of the present disclosure may provide a user with network connections based on either dynamic parameters (i.e., a dynamic zone) or user-selected parameters (i.e., a predefined zone). However, the level of interaction available to the platform user with other users in a particular zone may be qualified by the user's association with the zone. For example, in a zone having network connections established based on dynamic parameters (e.g., user location), the platform may provide the user with a first set of functions, including, but not limited to viewing, posting, liking, sharing, or otherwise interacting with content in the zone. However, in a zone with network connections established based on user-selected parameters (e.g., a remote location on a map), the platform may provide the user with only a second set of functions, which may only be a subset of the first set of functions (e.g., viewing, but not posting or sharing privileges).

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Platform Configuration

The platform of the present disclosure may enable the sharing of content between users in a common zone. The content may comprise textual, graphical content, audio content, or any combinations thereof. The users may access the platform via, for example, a computing device 600. Computing device 600 may be a mobile computing device such as, for example, but not limited to, a user's smartphone or tablet device. The mobile computing device may comprise location detection components and software such as, for example, a global positioning system (GPS), triangulation means, internet protocol (IP) address tracking, and the like.

A zone based anonymous content sharing application of the platform may be installed on computing device 600. The application may enable the device user to access the platform of the present disclosure. In turn, the platform, through the application, may be granted access to the location data provided through the location detection modules associated with the user's device.

Having the user's location data, the platform may then be enabled to build a network zone for the user. The platform may connect the user with other platform users who fall into the user's zone. Once connected, the platform may be enabled to display all content shared to the platform within the zone.

Consistent with embodiments of the present disclosure, the zone may be established several ways. For example, in various embodiments, the zone may be associated with a dynamically calculated area around a user. The dynamic area may be calculated based on a predefined radius extending from the location of the user. The size of the radius may be determined by, for example, a platform administrator or, in some embodiments, the user of the platform.

In various other embodiments, the zone may be associated with a predefined area to which the user may proximately be located. The predefined area may include, but not be limited to, for example, a region (e.g., an area defined on a map), a campus (e.g., school, mall, park), physical infrastructure (e.g., a building or set of buildings), a network connection (e.g., Wi-Fi, Local Area Network, Wide-Area network), and the like.

Such predefined areas may be determined and set by the platform administrators. For example, the administrators may divide a given city into quadrants, and based on which quadrant of the city a user is in, the platform may connect users within the quadrant. In further embodiments, predefined area may be determined by the selection of a center-point and may be designated by an area formed by a specified radius emanating from the center-point chosen by the administrators. In still further embodiments, predetermined area may be made up of any shape or size that may be plotted onto a map.

Still consistent with embodiments of the present disclosure, the platform may enable a user to select a zone by specifying a remote area to which the user is not otherwise located within or in proximity thereto. Such zone may be referred to as a ‘peek’ zone.

To join a peek zone, the platform may enable a user to select a area on a map or an area from a list of predefined areas. As described above, the predefined areas may include, but not be limited to, for example, a region (e.g., an area defined on a map), a campus (e.g., school, mall, park), physical infrastructure (e.g., a building or set of buildings), a network connection (e.g., Wi-Fi, Local Area Network, Wide-Area network), and the like. In turn, the platform may connect the user to other users who are otherwise located within or in proximity to the selected area.

Accordingly, user-selected zones of the present disclose may be classified as peek zones), whereas zones based on dynamic parameters (e.g., user-location in proximity to dynamic or predefined areas) may be classified as dynamic zones throughout the present disclosure.

To better disclose the differences between a peek zone and a dynamic zone, the following non-limiting example is provided: a first user may a select a remote area and be connected to a second user in the area. Here, the first user may have no geographical or organizational association with the area (i.e., the first user is peeking into the area), while the second user may have a geographical or organizational association with the area (i.e., the second user is located within the area). Accordingly, the area may be classified as a peek zone for the first user, while for the second user the area may be classified as a dynamic zone. As will be detailed below, the functionality provided to user by the platform may differ based on, for example, the classification of the zone.

Having established a zone for the user (e.g., a peek or dynamic zone), the platform may connect the user to other users within the zone. Based on a corresponding classification of zone, the users' interaction with each other in the zone may be limited. For example, users within a dynamic zone may view and share content to and from others within their dynamic zone. However, users in a peek zone may be limited to only viewing the content that is being shared within their peek zone.

In yet further embodiments of the present disclosure, the zone may be tied to a subject matter, organization, affiliation, or other non-geographic parameter (hereinafter referred to as ‘peek’ topics). The peek topic may be created by a user or administrator of the platform. In turn, users of the platform may select to join a zone associated with a desired category.

Consistent with embodiments of the present disclosure, platform content may be viewed and shared anonymously or with an optional, static or dynamic username. In various embodiments, the platform may be enabled to receive and display comments on content, “up votes” and “down votes” on posts, the location of where the post originated (e.g., a specific location or generalized proximate region), commands to report the post to administrators or forward the post on to others by social media channels such as Facebook, Twitter, or other similar means.

The platform may arrange and display shared content in various manners. For example, in some embodiments, the content may be displayed in order of the newest to oldest post, the most popular to least popular post, a set of posts that are related to a specified topic, or a set of posts that have originated in a specified zone. A user of the platform may be enabled to select a desired arrangement of display.

II. Platform Operation

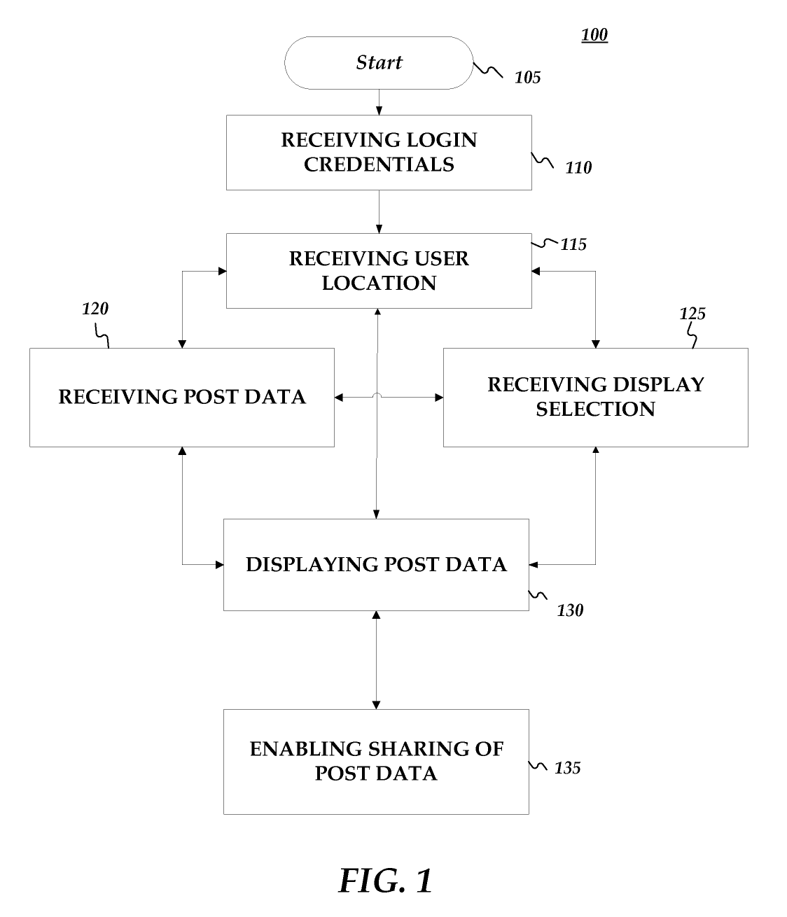

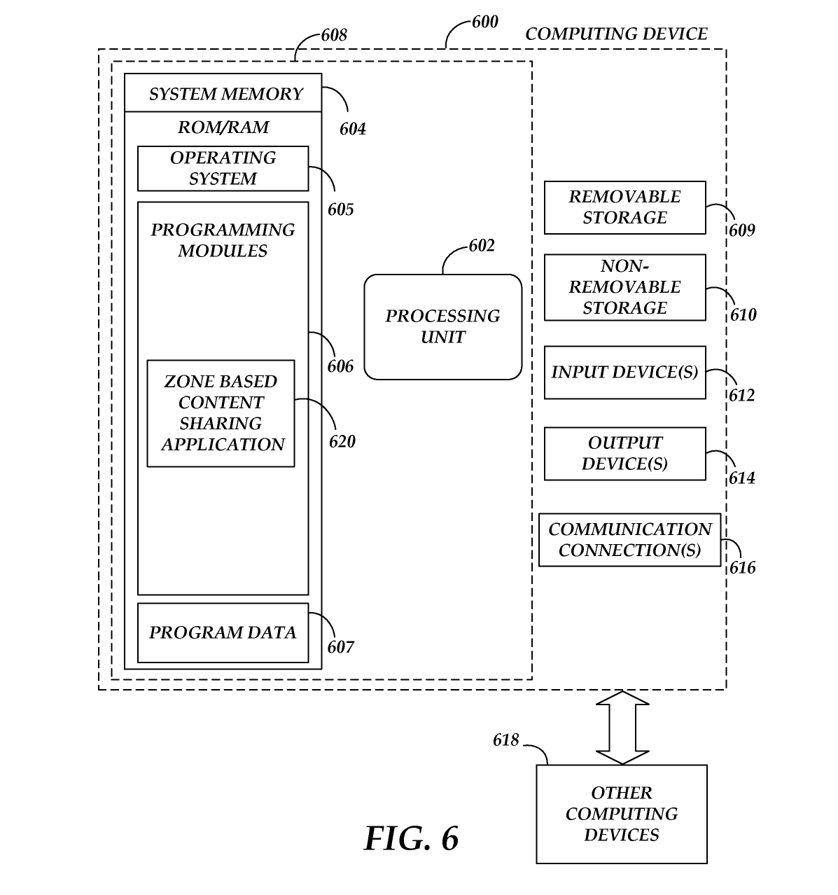

FIG. 1 is a flow chart setting forth the general stages involved in a method 100 consistent with an embodiment of the disclosure for providing a platform. Method 100 may be implemented using a computing device 600 as described in more detail below with respect to FIG. 6. For the purposes of this illustrative method, computing device 600 may comprise, for example, a mobile computing device such as a smartphone or tablet.

Although method 100 has been described to be performed by a computing device 600, it should be understood that, in some embodiments, different operations may be performed by different networked elements in operative communication with computing device 600. For example, a server may be employed in the performance of some or all of the stages in method 100. The server may be configured much like computing device 600. Moreover, although the content, as posted to the platform by a user, is illustrated as textual content, embodiments of the present disclosure may include any type of content (e.g., graphical and/or textual).

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 100 will be described in greater detail below.

Method 100 may begin at starting block 105 and proceed to stage 110 where computing device 600 may receive user login credentials. User login credentials may serve to identify the user account that is accessing the platform without provide any information that may serve to identify the device or the user. In this way, each user interaction with the platform may be attributed to the device from which the interaction originated without also identifying the user. For example, upon launching the platform for the first time, the platform may assign computing device 600 an account associated with a random user ID. In turn, the account may be used to identify all interactions with the platform originating from the device.

In accordance with other embodiments of the present disclosure, user login credentials may include, but not be limited to, device identification information, such as, for example, an International Mobile Station Equipment (IMSE) number, an Integrated Circuit Card ID (ICCID), a Mobile Equipment Identifier (MEID), Electronic Serial Number (ESN) or the like. In other embodiments of the present disclosure, user login credentials may comprise of a phone number or email address associated with the device. In still further embodiments, user login credentials may comprise a username and/or password associated with the platform. The platform may receive the login credentials automatically from computing device 600 upon activation of the platform or the platform may require a user input of user login credentials.

From stage 110, where computing device 600 receives user login credentials, method 100 may advance to stage 115 where computing device 600 may receive user location data. User location data may be data which serves to identify the location of the device hosting the platform and may be comprised of any data which may be used to identify the location of computing device 600. The data may include, for example, but not be limited to, the GPS coordinates of the device, the identification of cellular towers that the device may be or may have recently been connected to which may be used to estimate or triangulate the position of the device, the identification of a known or previously connected Wi-Fi network, communication with other devices of known positions by means of Bluetooth or the like, a user input of location information or any other types of data which may be used in determining the location of a computing device. The location data may be used to determine (whether precisely, approximately, or by way of estimation) the device location.

Upon receipt of user location data, the platform may be operative to then derive a given user's location by associating the corresponding device's determined location with the user's location. In the aggregate, the platform may therefore be operative to track and plot the location of every user on a map. The platform may be configured to receive user location data at any interval of time or upon any set of triggers, for example, the platform may receive a user's location data at any time the user uploads an input to the platform, such as by submitting content, a comment, an up vote or the like. In other embodiments the platform may be configured to receive a user's location data at automatic intervals, such as, for example, every 60 seconds.

Once computing device 600 receives user location data in stage 115, method 100 may continue to any of stage 120, stage 125 or stage 130. In stage 120, computing device 600 may receive content to post to the platform (hereinafter referred to as “post data”). Post data may comprise any data that has been received through a user's input into the platform via the user device. For example, post data may include but not be limited to graphical, textual, audio/visual content, written messages (“posts”), written responses to posts (“comments”), and non-written responses to posts such as “up-voting,” “down-voting” or flagging a post for review.

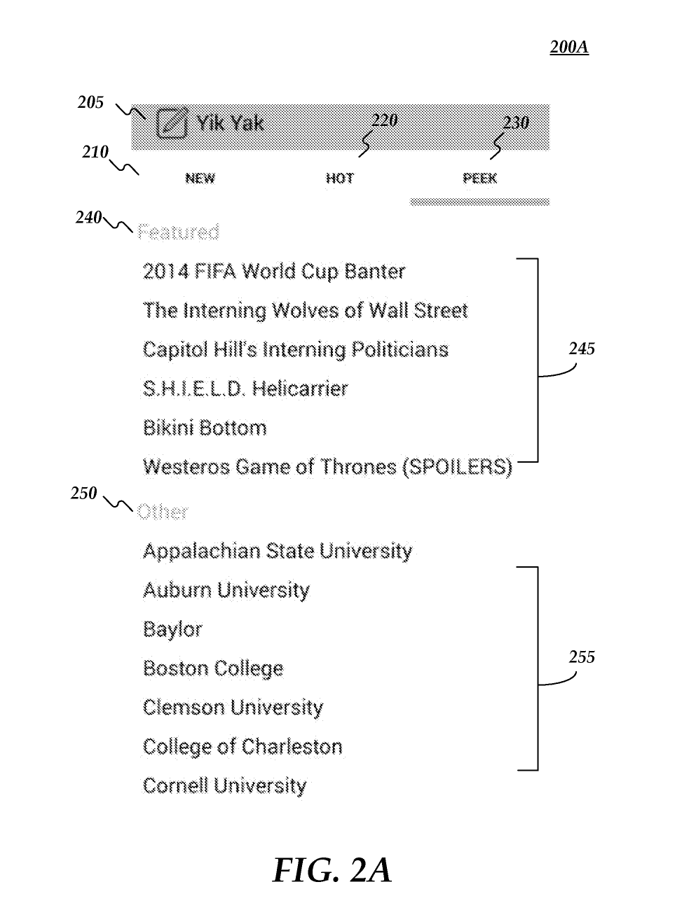

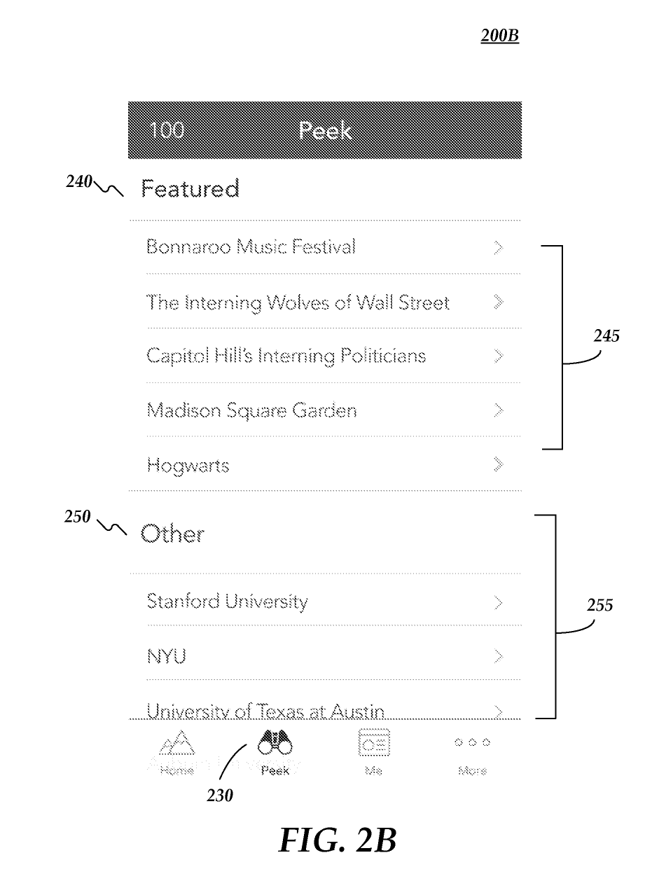

FIG. 2A illustrates an embodiment of a user interface 200A through which the platform may receive and display content to the user via computing device 600. FIG. 2B illustrates another embodiment of a user interface 200B through which the platform may receive and display content to the user via computing device 600. In the user interface, the user may input content to post by selecting a write message button 205. In response to the selection of a write message button 205, the platform may display a text box which may receive a message input from a user.

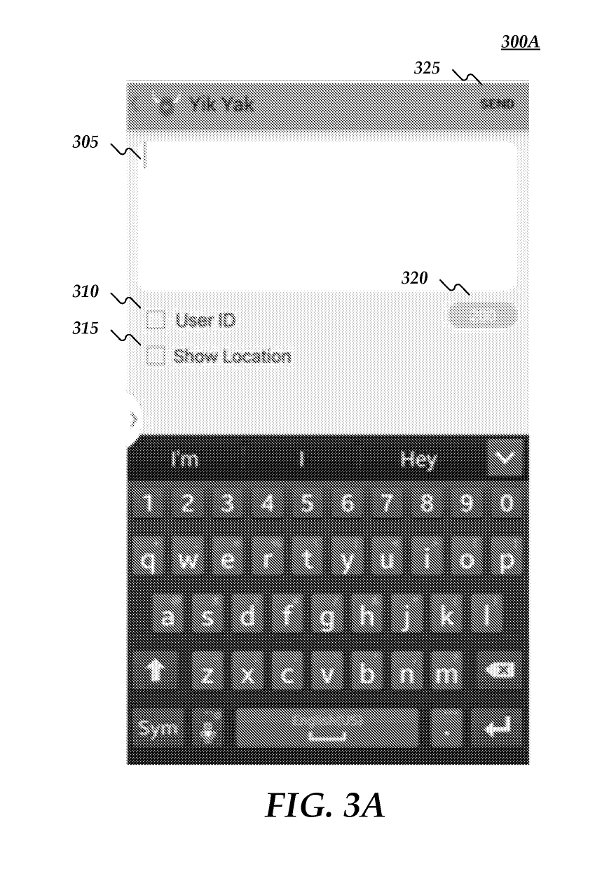

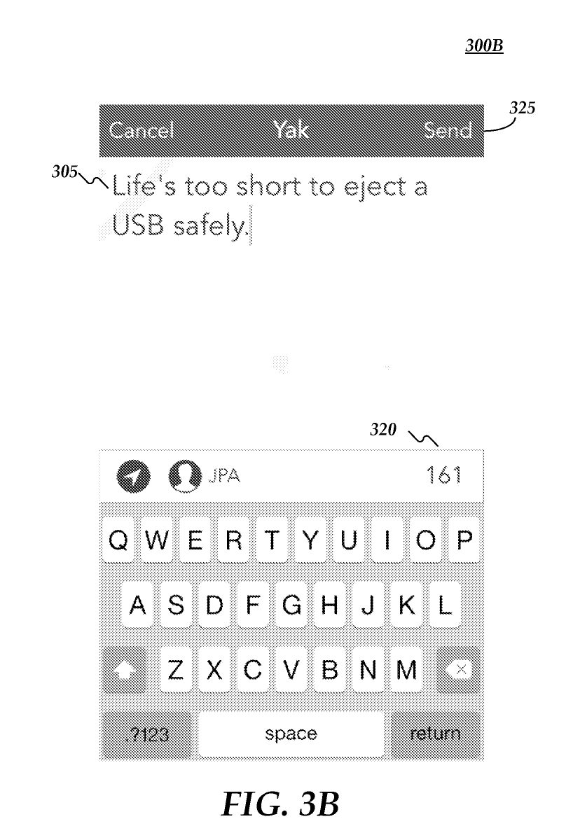

FIG. 3A illustrates one embodiment of an input screen 300A. FIG. 3B illustrates another embodiment of an input screen 300B. An input screen may include, for example, an input field 305 in which the user may provide content to post to the platform. In various embodiments, input field 305 may be limited in size, as may be indicated to the user by a limit indicator 320.

Consistent with embodiments of the present disclosure, the platform may enable a user to toggle a User ID check box 310 which may enable the display of the user's ID along with the posted content. For example, in some embodiments, the platform may enable a user to designate a temporary username or ‘handle’ for display with the posted content. In turn, this user ID may be displayed to other platform users viewing the posted content.

Further, input screen 300A may provide a display message location check box 315 which may enable the display of the user's location along with the post. If check boxes 310 and/or 315 have been selected, the platform may post the content inputted into input field 305 the user's ID and/or the most accurate location data available in relation to the input, respectively.

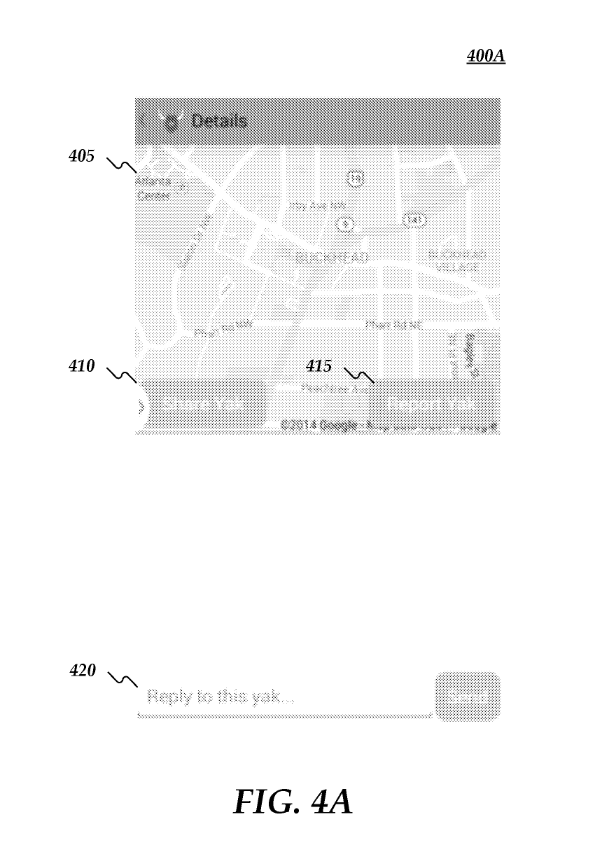

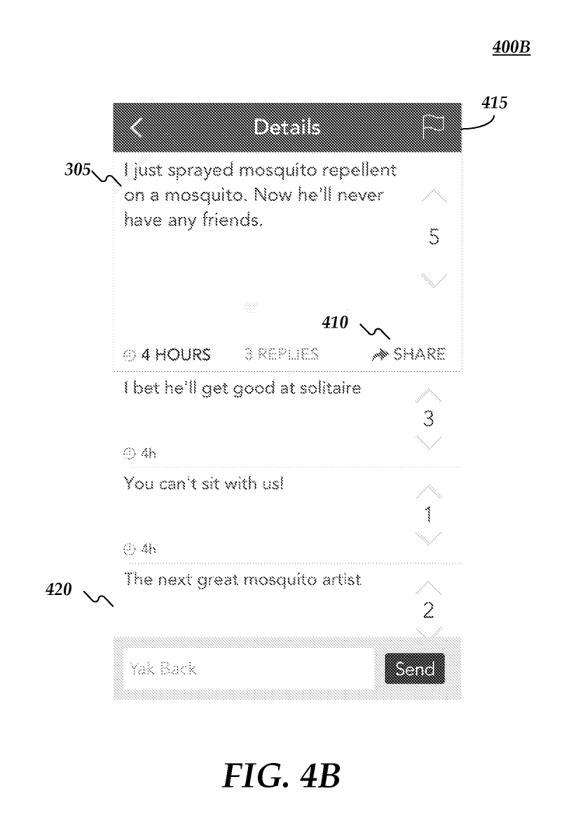

For example, the platform may provide the user's GPS coordinates (at the time of uploading post data, such as a post) for display, which may be displayed for example, as a pinpoint on a map. Platform users who view the shared content may then select the content, via the platform, to view various details associated with the content. FIG. 4A illustrates an embodiment of a details screen 400A. FIG. 4B illustrates another embodiment of a details screen 400B.

If check box 315 has not been selected, the platform may provide a general location of where the post data originated, but not a precise one, which may be displayed as, for example, a portion of a map 405 including the point in which the post was made, but without providing a pinpoint location of it. If check box 315 has been selected, map 405 may display a portion of the map 405 with an indicator of the location of the user/device within map 405.

Furthermore, in some embodiments, a random offset may be added to the user's location data to add further inaccuracy to the display of the user's location. For example, some random offset may be added to a user's GPS coordinates, enabling the platform to display a portion of a map centered on the offset GPS coordinates. Such a random offset may fall within a predetermined range of possible values. In this way, a user may elect to obscure their precise location when interacting with the platform. In other embodiments of the present disclosure, the platform may display no location data at all in response to receiving a command to not display message location.

In details screen 400A, platform users may be enabled to repost (or share) the posted content with other users by selecting a share button 410 and/or report or flag the posted content to platform administrators by selecting report button 415. Moreover, in some embodiments, platform users may be enabled to engage in a discussion over the posted content through interface 420.

Post data may be received by the platform and maintained in a database for display. The database may be stored by a centralized server in communication with computing device 600. The platform may collect other information from computing device 600 not directly input by a user in association with post data. For example, the platform may receive location data such as GPS coordinates of computing device 600 at the time the post data was received by the platform. As previously discussed above, the platform may be configured to receive location data at various intervals or in association with various triggering events. Furthermore, the platform may associate information sufficient to identify the user account that the received post data originated from.

After computing device 600 receives post data in stage 120, method 100 may proceed to any of stage 115, stage 125, or stage 130. In stage 125, computing device 600 may receive a display selection. The display selection may be received from, for example, the user selecting to view content in the order of time (e.g., via ‘new’ posts button 210), popularity (e.g., via ‘hot’ posts button 220), or predefined zone (e.g., a ‘peek’ zone via ‘zones’ button 230). Accordingly, the platform may be enabled to display the latest and/or most popular content posted within a ‘dynamic’ zone corresponding to, for example, the user's location. Similarly, the display selection may be received from, for example, the user selecting one of the peek zones 255, in which event the platform may be enabled to display the content shared within the corresponding peek zone.

A display selection may be a user input indicating which set of posts a user desires to be displayed by the platform. In response to a received display selection, the platform may display different sets of posts or identical sets of posts in different orders. For example, a default display selection received by the platform upon receiving login credentials in stage 110 may be the ‘new’ posts display. A ‘new’ posts display selection (i.e., ‘new’ posts button 210) may cause the platform to display posts in order of newest to oldest. The display may be limited to a certain number of posts, for example, the platform may be configured to only display the most recent 100 posts. Furthermore, the posts displayed for a given user may be limited to a geographical area that is localized to user as described throughout the present disclosure.

Referring again to FIG. 2A, the platform may contain buttons enabling a user to selectively arrange displayed content, via, for example, a ‘new’ posts button 210, a ‘hot’ display button 220 and a ‘peek’ display button 230. A ‘hot’ posts display selection may cause the platform to display posts in order of their post score from highest to lowest. For example, the platform may display the most recent 100 posts in order of highest post score to lowest.

Still consistent with embodiments of the present disclosure, the platform may receive a user selection of a ‘peek’ topic 245 or a ‘peek’ zone 255. In some embodiments, zones may be moderated by a platform administrator who may first view a post and accept or reject it for inclusion with the set of posts within a given zone.

Selection of ‘peek’ button 230 may cause a display of a list of predefined zones which may cause the platform to display posts based on, for example, featured topics 240 (e.g., ‘peek’ topics 245) or specified zones 250 (e.g., ‘peek’ zones 255). For example, the platform may enable a user to select a college from a list of colleges across the country, which may cause the platform to display content shared within a zone associated with that college. Likewise, the platform may enable a user to select from a listed of featured topics which will cause the platform to display content related to that topic.

FIGS. 2A and 2B illustrate embodiments of a user interface of the platform showing a list of featured ‘peek’ topics 240 and a portion of a list of ‘peek’ zones 250. In some embodiments of the present disclosure, posts made to various ‘peek’ topics may only be displayed when a corresponding ‘peek’ post topic associated with the post is selected (i.e., posts uploaded to a given ‘peek’ topic may not be displayed under a ‘new’ posts selection). In this way, ‘peek’ topics may encourage anonymous discussions of various topics, unrelated to the location of the posters.

A selection of a ‘peek’ zone 255 may enable users to view content shared outside of their ‘dynamic’ zone. Although FIGS. 2A and 2B displays a list of predefined peek zones 255, in some embodiments, the platform may enable a user to define a particular point on a map at which point the platform may display the post data in the vicinity of the selected point. Furthermore, a user may be able to specify the metes and bounds of a zone in which they desire to view post data.

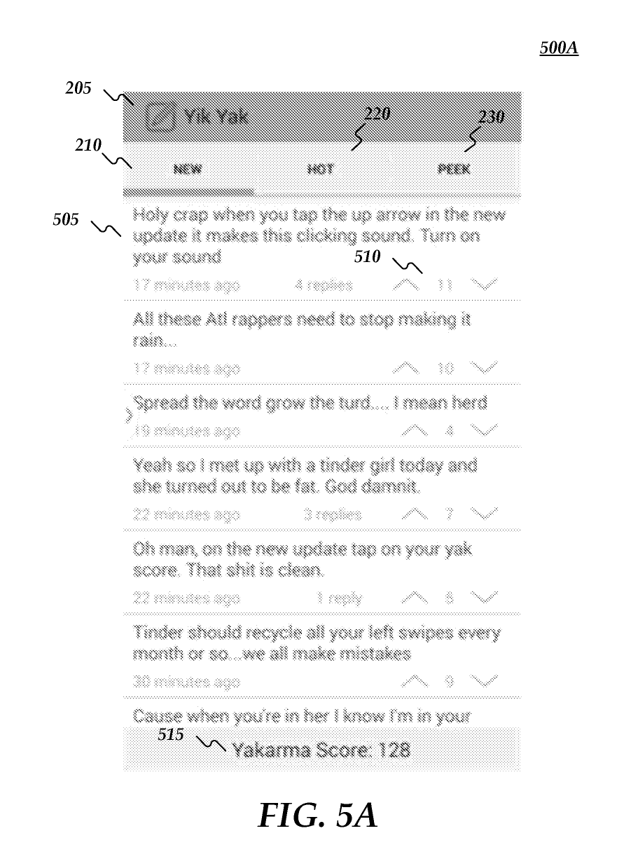

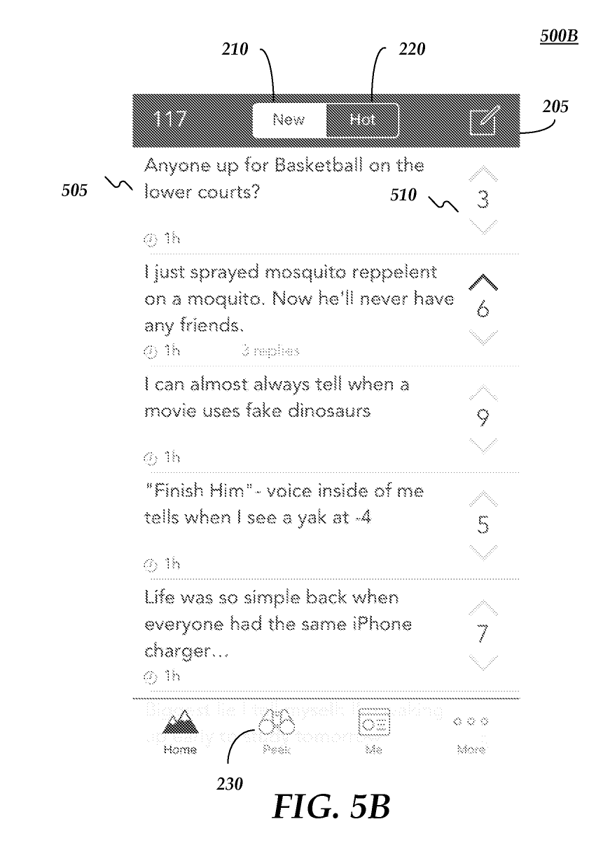

After computing device 600 receives a display selection in stage 125 method 100 may proceed to any of stage 115, stage 120, or stage 130. In stage 130, computing device 600 may display post data. FIG. 5A illustrates an embodiment of the platform displaying content shared by platform users in a shared content interface 500A. FIG. 5B illustrates another embodiment of the platform displaying content shared by platform users in a shared content interface 500B. Shared content 505 may be displayed to a platform user upon a selection of ‘new’ posts button 210. The content may be displayed with, for example, an indication of time the content was shared and quantity of replies in the discussion associated with the shared content (as mentioned with reference to element 420 of FIGS. 4A and 4B).

In various embodiments, the platform may provide an ‘up vote’ and ‘down vote’ button 510, which may enable a user to register their approval or disapproval of a given post. The platform may provide a sum of the ‘up votes’ and ‘down votes’, wherein an ‘up vote’ may be represented by a +1 and a ‘down vote’ may be represented by a −1. This sum may be referred to as a user's score 515. In some embodiments, once a post has received a threshold level of up-votes, the user who posted the corresponding content may be prompted to optional reveal his or her identity or other identifying means (user name or handle).

As described above, the platform may display post data in response to receiving a display selection. The post data displayed by platform may include but not be limited to written messages comprising the posts, comments responding to posts, handles of users, post scores, and location data of the post, which may be represented by for example, a portion of a map with or without a point indicating a precise location.

The platform may display different sets of post data for each user, based on the user's location (e.g., ‘dynamic’ zone′). As discussed above, the dynamic zone may be defined around a given user at any shape or size. For example, the platform may display post data submitted within a 1.5 mile radius of the user. In other embodiments, the platform may place a square with predetermined side lengths around a user on a map, using the user's location data as the center point of the square, and display posts that fall within the square to that user. In this way, the user may view and share post data within their individual vicinity.

Still consistent with embodiments of the present disclosure, the platform may be configured to use a standardized dynamic zone, such as, for example, a square with sides of one mile, or it may be configured to use variable dynamic zone based on various conditions specified by an administrator of the platform. For example, in a highly densely populated area, such as a city, it may be desirable to assign users a smaller dynamic zone, whereas in a sparsely populated area it may be desirable to assign users a larger dynamic zone. As such, in various embodiments of the present disclosure, the platform may use various algorithms to create a variety of dynamic zones.

It should be understood that a dynamic zone may be comprised of any shape or size, and may even be of variable shape and size based on various conditions specified by a platform administrator. Such conditions may include, but not be limited to, population density, user density, density of posts made, frequency of posts made, and frequency of posts viewed.

As described above, the platform may receive instructions to display post data from ‘peek’ zones 255 and ‘peek’ topics 245 which are predetermined areas and topics, determined by a platform administrator. For example, a platform administration may define a ‘peek’ zone to be the area around a given venue. If the platform receives a command to display that ‘peek’ zone 255, then the platform may display post data originating from that venue, regardless of whether the user is present within that zone or not. In this way, users may view post data from remote areas, such as other cities, college campuses, venues or any other predefined area. Likewise, if a ‘peek’ topic 245 has been selected for display, the platform may display post data relating to the specified ‘peek’ topic. This may enable users to anonymously discuss and comment on various predefined topics, regardless of their location.

After computing device 600 displays post data in stage 130, method 100 may proceed to any of stage 115, stage 120, stage 125 or stage 135. In stage 135 computing device 600 may enable sharing of post data. For example, when displaying a particular post, the platform may receive a command to share the post (e.g., button 410 of FIGS. 4A and 4B). The command to share the post may specify a means of sharing, such as, for example, but not limited to, through Facebook, Twitter, or downloading an image of the post. The platform may be integrated with other platforms, such as Facebook and Twitter, such that upon receiving a command to share with another platform, computing device 600 may launch the selected platform and upload an image of the post to it. If the platform receives a command to download an image of the post, the platform may export an image of the post to memory storage of computing device 600.

III. Platform Architecture

The platform may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform may be hosted on a centralized server, such as, for example, a cloud computing service. Although method 100 has been described to be performed by a computing device 600, it should be understood that, in some embodiments, different operations may be performed by different networked elements in operative communication with computing device 600.

FIG. 6 is a block diagram of a system including computing device 600. Consistent with an embodiment of the invention, the aforementioned memory storage and processing unit may be implemented in a computing device, such as computing device 600 of FIG. 6. Any suitable combination of hardware, software, or firmware may be used to implement the memory storage and processing unit. For example, the memory storage and processing unit may be implemented with computing device 600 or any of other computing devices 618, in combination with computing device 600. The aforementioned system, device, and processors are examples and other systems, devices, and processors may comprise the aforementioned memory storage and processing unit, consistent with embodiments of the invention.

With reference to FIG. 6, a system consistent with an embodiment of the invention may include a computing device, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination. System memory 604 may include operating system 605, one or more programming modules 606, and may include a program data 607. Operating system 605, for example, may be suitable for controlling computing device 600's operation. In one embodiment, programming modules 606 may include zone based content sharing application 620. Furthermore, embodiments of the invention may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 (e.g., zone based content sharing application 620) may perform processes including, for example, one or more method 100's stages as described above. The aforementioned process is an example, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

Embodiments of the present disclosure may comprise a processing unit and memory storage in operative communication with to the processing unit. In some embodiments, the memory storage and the processing unit may be in remote communication (e.g., the memory storage may be associated with a first computing device, while the processing unit may be associated with a second computing device). The memory storage may comprise a set of computer-readable instructions for operating the processing unit. Upon executing the instructions, the processing unit may be operative to determine a first user's location; establish a first zone based on the first user's location; receive a first content from the first user; determine at least one other user within the first zone; and share the first content with the at least one other user.

In further embodiments, upon executing the instructions, the processing unit may be operative to determine a first user's location; establish a first zone for the first user based on the first user's location; provide the first user with a first set of functions configured to enable the first user to interact with other users within in the first zone; determine a second user's location; determine that the second user is not located within the first zone; receive a first request from the second user to interact with the other users within the first zone; and provide, in response to the received first request, the second user with a second set of functions configured to enable the second user to interact with the other users within the first zone.

It should be understood that, in some embodiments, different operations in the above mentioned embodiments may be performed by different networked elements in operative communication with the processing unit. While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the invention.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

Insofar as the description above and the accompanying drawing disclose any additional subject matter that is not within the scope of the claims below, the inventions are not dedicated to the public and the right to file one or more applications to claims such additional inventions is reserved.

The following is claimed:

1. A method comprising:
determining a first user's location;
establishing a first zone based on the first user's location;
receiving a first content from the first user;
determining at least one other user within the first zone; and
sharing the first content with the at least one other user.

2. The method of claim 1, further comprising:
receiving a second content from the at least one other user;
determining the at least one other user's location; and
sharing the second content with the first user if the at least one other user's location was determined to be within the first zone.

3. The method of claim 2, wherein determining the at least one other user's location comprises:
establishing a second zone based on the at least one other user's location.

4. The method of claim 3, wherein sharing the second content with the first user comprises:
sharing the second content with the first user if at least a portion of the first zone overlaps with a portion of the second zone.

5. The method of claim 1, further comprising:
receiving a second content from the at least one other user;
determining the at least one other user's location;
establishing a second zone based on the at least one other user's location; and
sharing the content to at least one additional user located in the second zone.

6. The method of claim 5, further comprising:
receiving a request from the first user to view content shared in the second zone;
determining, in response to the received request, that the first zone and the second zone do not overlap;
enabling, in response to the determination that the first zone and the second one do not overlap the first user to view content shared in the second zone while prohibiting the first user from sharing content with the at least one other user the second zone.

7. The method of claim 1, further comprising:
receiving a request from the first user to view content shared in a second zone, the second zone not overlapping with the first zone;
enabling, in response to the received request the first user to view content shared in the second zone while prohibiting the first user from sharing content with the at least one other user the second zone.

8. The method of claim 7, further comprising:
displaying a list of predefined zones located remotely from the first user, the list of predefined zones being associated a location that is not within the first zone corresponding to the first user; and wherein receiving the request to view content shared in the second zone comprises:
receiving a selection from the list of predefined zones.

9. The method of claim 1, further comprising:
enabling a user to select a location on a map.

10. The method of claim 9, further comprising:
establishing a second zone for a user-selected location on the map;
determining whether at least a portion of the first zone overlaps at least a portion of the second zone; and
when the first zone overlaps the second zone in the at least one portion, enabling the first user to share and view content with at least one other user located within at least one of the following:
the first zone, and
the second zone;
when the first zone does not overlap the second zone in the least one portion, enabling the first user to share and view content within the first zone while enabling the first user to only view content, but not share content, within the second zone.

11. The method of claim 1, wherein establishing the first zone based on the first user's location comprises:
determining a predefined zone that is at least one of the following:
surrounding the first user's location, and
closest in proximity to the first user's location.

12. The method of claim 11, wherein establishing the first zone based on the first user's location comprises:
extending a predefined radius from the first user's location.

13. A computer-readable medium having a set of instructions stored thereon which, when executed by a computing device, are configured to perform a method, the method executed by the set of instructions comprising:
determining a first user's location;
establishing a first zone for the first user based on the first user's location;
providing the first user with a first set of functions configured to enable the first user to interact with other users within in the first zone;
determining a second user's location;
determining that the second user is not located within the first zone;
receiving a first request from the second user to interact with the other users within the first zone; and
providing, in response to the received first request, the second user with a second set of functions configured to enable the second user to interact with the other users within the first zone.

14. The method of claim 13, wherein providing the second user with the second set of functions to interact with the other users within the first zone comprises:
providing the second user with a subset of the first set of functions.

15. The method of claim 13, further comprising:
establishing a second zone for the second user based on the second user's location;
receiving a second request from the first user to interact within the second zone;
determining that the first user is not within the second zone; and
providing the first user with the second set of functions configured to enable the first user to interact with the second user within the second zone.

16. The method of claim 15, wherein providing the first user with the second set of functions configured to enable the first user to interact with the second user within the second zone comprises:
providing the first user with a subset of the first set of functions.

17. A system comprising:
a memory storage; and
a processing unit associated with the memory storage, the processing unit being operative to:
determine a first user's location;
establish a first zone based on the first user's location;
receive a first content from the first user;
share the first content with at least one other user associated with the first zone; and
providing a plurality of functions to all users associated with the first zone, wherein users physically present within the first zone receive the plurality of functions and other users not physically present within the first zone receive a subset of the plurality of functions.

18. The system of claim 17, wherein the processing unit is further operative to:
receive a second content from the at least one other user;
determine the at least one other user's location; and
share the second content with the first user if the at least one other user's location was determined to be within the first zone.

19. The system of claim 17, wherein the processing unit being operative to establish the first zone comprises the processing unit being operative to:
determine a predefined zone that is at least one of the following:
surrounding the first user's location, and
closest in proximity to the first user's location.

20. The system of claim 19, wherein the first zone based on the first user's location comprises a geographic area encompassing the first user's location.
